(19) United States
(12) Patent Application Publication
(10) Pub. No.: US 2008/0171632 A1
(43) Pub. Date: Jul. 17, 2008

(54) ELECTRIC INPUT CLUTCH FOR A VEHICLE AND METHOD FOR USING THE SAME

(75) Inventor: Anthony D. Van Allen, Nevada, IA (US)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/623,545

(22) Filed: Jan. 16, 2007

(51) Int. Cl. B60W 10/00

(52) U.S. Cl. 477/79

(57) ABSTRACT

A transmission control system for a vehicle. The control system has a control unit that receives a plurality of inputs from the vehicle and the vehicle operator. Then based upon these inputs the control unit sends a plurality of output signals to an engine, an input clutch, and a transmission in order to selectively operate each of these components to actuate the axle and wheels of a vehicle.

### BACKGROUND OF THE INVENTION

This invention relates to a vehicle transmission. More specifically, this invention relates to a transmission control unit having a hydromechanical transmission that is controlled by an electric input clutch.

There are a number of vehicles that desire to have an “automatic transmission” for ease of driving and for increased utility. These include ATVs, tractors, utility work vehicles and automobiles. These vehicles generally have common requirements for low cost, high efficiency and good controllability. Hydromechanical transmissions are frequently considered for these vehicles and may have either a continuous ratio throughout a speed range or have a limited range of speed. If the hydromechanical transmission (HMT) does not have a continuous ratio from zero speed upward, mechanical startup clutches are used. Additionally, if the HMT does have continuous ratio from zero speed upward, the clutch may be used as an anti-stall or as a safety feature. These clutches may be manually actuated or actuated by input speed with centrifugal weight. For manual clutches, the automatic feature is reduced. When speed actuated, the startup speed and fully engaged speed are spaced apart and the relationship is fixed.

Thus, there is a need in the art for a hydromechanical transmission with an electrically operated input clutch between the engine and the transmission such that the input clutch is actuated automatically to achieve improved control of the transmission and engine package. Therefore, the electric input clutch could be controlled to provide some output torque responsiveness at start up to improve slow speed controllability, and to decouple the engine and transmission during an emergency, break down or unusual operating conditions.

Thus, it is a primary object of the present invention to provide a transmission control system having an automatic transmission.

Another object of the present invention is to provide a transmission control unit that improves efficiency of a vehicle transmission.

Yet another object of the present invention is to provide a method of operating a hydromechanical transmission that utilizes an electrically actuated input clutch.

These and other objects, features, or advantages of the present invention will become apparent from the specification and claims.

### BRIEF SUMMARY OF THE INVENTION

A transmission control system and the method of using the same. The transmission control unit assembly has a control unit that receives a plurality of inputs from a vehicle. The transmission additionally has an engine that is directly and operably connected to the control unit and an input clutch. The input clutch is electrically connected to the control unit and additionally connected to a hydromechanical transmission that is also electrically connected to the control unit. Thus, based on the plurality of inputs received by the control unit, the control unit is able to selectively operate the engine, input clutch, and hydromechanical transmission to control and actuate the axle and wheels of the vehicle.

### BRIEF DESCRIPTION OF THE DRAWINGS

FIG. 1 is a schematic diagram of a hydromechanical transmission with an input clutch and engine; and

FIG. 2 is a schematic diagram of a transmission control system.

### DETAILED DESCRIPTION OF THE PREFERRED EMBODIMENT

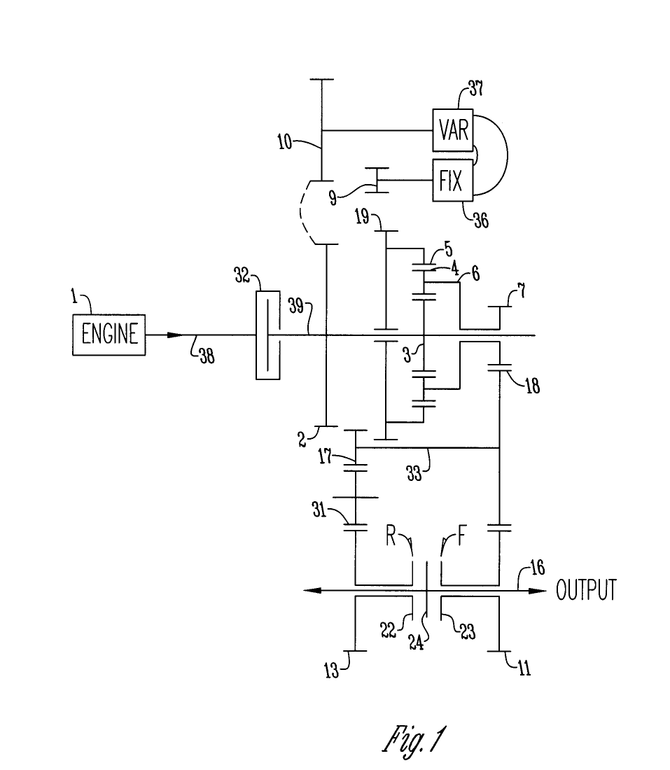

FIG. 1 shows a single mode HMT 71 with a forward/reverse range shift at the output. There may be more than one forward or reverse range shift ratio. HMT 71 does not have zero speed capability if the input is rotating; the minimum speed ratio of output to input is greater than zero. Power from engine 1 travels through shaft 38 to electric input clutch 32. When clutch 32 is closed, power flows through shaft 39 to the input of transmission 71, and through gear set 2/10 into the hydrostatic variable unit 37. As this is a single mode transmission, V-unit 37 starts at or near full stroke and power may be transmitted through fixed unit 36 to gear set 9/19 and to planetary ring gear 5. Power is also delivered through shaft 39 to planetary sun gear 3, creating parallel power paths. Power is transmitted from both paths to planet gears 4, to carrier 6, to gear set 7/18 and to idler shaft 33. Because ring 5 is speed controlled by F unit 36, a variable speed is controlled at idler shaft 33. HMT 71 in FIG. 1 is shown as an example and may be of any type that has a minimum ratio greater than zero and has a range shift at the output.

In forward mode, F clutch element 23 is connected to element 24 and output shaft 16 is driven in the same direction as input shaft 38 by gear set 18/11. In reverse mode, R clutch element 22 is connected with element 24 and output shaft 16 is driven in the opposite direction of input shaft 38 by gear set 17/31/13. For this disclosure numeral 38 represents the shaft extending from the engine 1 to the input clutch 32 and thus is considered an input shaft of input clutch 32 and an output shaft of engine 1. The F and R clutches may be dog-type, or multiple disc clutches, or other type, and may be actuated manually or with a controller.

Start up or input clutch 32 is selectively attached to the shaft 39 and thus can be mechanically connected to HMT 71. Input clutch 32 is also attached to the output shaft 38 of the engine 1. Input or start up clutch 32 in a preferred embodiment is a multiple disc with an electro mechanical actuating device such as a DC motor driving a ball ramp mechanism but may be of any type that can be modulated between the closed and opened positions electrically.

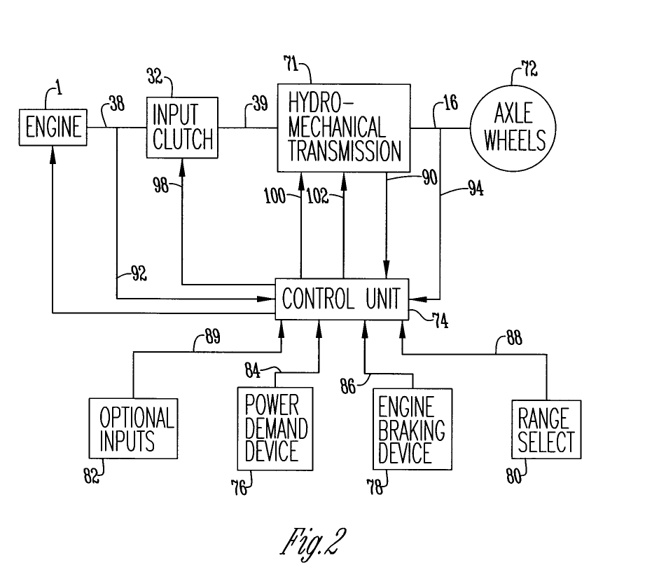

As shown in FIG. 2, the engine 1 is thus connected to the input clutch 32 by shaft 38 such that when input clutch 32 is engaged the shaft 39 connects the engine 1 to the hydromechanical transmission 71. The hydromechanical transmission then provides an output through the output shaft 16 that is able to actuate the axle and wheels 72 of a vehicle. The engine 1, input clutch 32, and hydromechanical transmission 71 are all controlled and operated by a controller or control unit 74. The control unit 74 receives a plurality of inputs from a power demand device 76, engine braking device 78, a range selecting device 80, other optional input devices 82, the hydromechanical transmission 71, and conventional sensors at both input shaft 38 and output shaft 16.

Specifically, the control unit 74 receives a power demand input signal 84 from the power demand device 76. The power demand device is any device that demands power. For example only, in one embodiment the power demand device could be a foot pedal, whereas in another embodiment the power demand device could be a hand lever. In either instance, actuation of the power demand device sends the power demand signal 84 to control unit 74.

The engine braking device 78 sends an engine braking device signal 86 to the control unit 74. Again, for example only, the engine braking device in one embodiment could be a foot pedal whereas in another embodiment the braking device could be a hand lever. Thus, the engine braking device is any device that sends an engine braking device signal 86 to the control unit 74.

The range select device 80 sends a range select signal 88 to the control unit 74. The range select device 80 may be any device that can send a range select signal, and for example only, may be a handle that moves from a first and second position representing forward and reverse directions of the vehicle.

Similarly optional input devices 82 send optional inputs 89 to the control unit 74. The optional input devices can include but are not limited to any auxiliary device that effects the operation of the vehicle. The optional input 89 also includes, for example only, information inputted into the control unit 74 by an operator.

The control unit 74 also receives a pressure signal 90 from the hydromechanical transmission 71, an input speed signal 92 from a conventional speed sensor associated with the input shaft 38, and an output speed signal 94 from a conventional sensor associated with the output shaft 16. Based upon all of these inputs the controller 74 is able to send a plurality of output signals, including an output clutch signal 98 to the input clutch 32 to modulate the clutch 32, a transmission ratio output signal 100 to the hydromechanical transmission 71 to set the ratio of the HMT 71, and finally a range output signal 102 to the hydromechanical transmission 71 to determine the position of the range clutches F and R. Thus, depending on the plurality of inputs the control unit 74 controls the engine 1, input clutch 32, and hydromechanical transmission 71 simultaneously to adjust to the inputs. In this way the control unit 74 selectively operates the engine 1, input clutch 32, and hydromechanical transmission 71 to actuate the axle and wheels 72.

Thus, control unit 74 regulates the vehicle system, and in an additional embodiment, may be present in more than one physical package. In a preferred embodiment the control unit 74 operates with digital logic but may use any logic type to make calculations in order to operate the transmission control system. Additionally, an operator may input information into the controller that effects the operation of the engine 1, input clutch 32 and hydromechanical transmission 71 within the transmission control system. Specifically, for example only, characteristics of the engine speed versus the clutch closure may be programmed into the controller 74 and then additionally regulated by the input speed signal 92 and output speed signal 94. Other additional similar types of information may be placed into the controller 74 to assist the operation of the controller. Additionally, in a preferred embodiment the control unit 74 communicates with the V-unit 37 of the HMT 71 and has control logic for the V-unit 37 as described in U.S. Pat. No. 5,560,203, though other control logics may be used.

In operation, when the vehicle is at rest clutch 32 is open and engine 1 is not connected to HMT 71. This allows starting engine 1 without any direct torque from HMT 71. Further, there is no possibility of vehicle creep until the operator signals for vehicle motion. When starting a vehicle from zero speed, the operator signals the controller 74 by actuating the power demand device 76 and sending the power demand signal 84 to the control unit 74 to deliver power from the engine 1 to the axle and wheels 72. Depending upon the amount of power demanded, the speed of engine 1 increases and an input clutch signal 98 causes clutch 32 to begin to modulate to a closed position. HMT 71 input shaft 39 starts to turn slowly and pressure in hydraulic units 37/36 starts to build higher. The amount of pressure built up may be controlled by clutch 32 modulation thus controlling HMT 71 output torque and low speed. Increased demand for power increases the engine speed and the amount of clutch 32 closure.

As the operator and program logic commands, control unit 74 strokes V-unit 37 to a smaller displacement. As V-unit 37 is stroked smaller, flow from F unit 37 reduces and rotational speed of gear set 9/19 reduces. This reduces the speed of ring 5 and increases the speed of carrier 6, gear set 7/18 and shaft 33. Thus, power flows to output shaft 16 through F or R clutches as defined by the range select signal 88. The control unit 74 then strokes the V-unit 37 from full positive to full negative displacement and output speed delivered to shaft 16 reaches a maximum.

When engine braking is signaled by the engine braking device 78 the engine braking input 86 is sent to the control unit 74. The power flow is reversed and the control unit generally reverses the control logic to slow the vehicle down. Clutch 32 transmits power equally during driving or braking. When the vehicle reaches the limit of HMT 71 ratio and engine speed drops, clutch 32 opens and may be modulated open thus possibly causing the vehicle to coast.

If there is a malfunction in the transmission, input clutch 32 may be opened, or disengaged automatically by the control unit 74 to allow for a free wheeling vehicle driveline, even if the speed of the engine 1 is high. Also, clutch 32 may be modulated or partially opened during a mismatch between wheel speed and ground speed such as might occur if a vehicle left the ground during a jump or when transitioning from ice to pavement. The modulation is determined by measuring the rate of transmission ratio changed.

Thus, disclosed is an improved engine transmission control system that uses a control unit 74 to improve upon the efficiency of a vehicle and to provide a transmission that automatically reacts to vehicle and controller inputs without manual actuation of a clutching element. Consequently, at the very least, all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A transmission control system for a vehicle comprising:
a control unit that receives a plurality of inputs;
an engine directly and operably connected to the control unit;
an input clutch electrically and operably connected to the control unit;
a transmission electrically and operably connected to the control unit;
wherein based upon the plurality of inputs from the vehicle the control unit selectively operates the engine, input clutch and hydromechanical transmission to actuate an axle and wheels.

2. The transmission control system of claim 1 wherein the control unit uses digital logic.

3. The transmission control system of claim 1 wherein the transmission is selectively operated by an output signal that determines a ratio of the transmission.

4. The transmission control system of claim 1 wherein the transmission is selectively operated by an output signal that determines a range of the transmission.

5. The transmission control system of claim 4 wherein the range has a forward and reverse clutch.

6. The transmission control system of claim 5 wherein the control unit electrically controls the forward and reverse clutch depending on the plurality of inputs.

7. The transmission control system of claim 1 wherein the plurality of inputs includes a pressure signal from the transmission.

8. The transmission control system of claim 1 wherein the control unit selectively operates the input clutch by automatically disengaging the input clutch.

9. The transmission control system of claim 1 wherein the input clutch is selectively operated as a function of transmission ratio of the transmission.

10. The transmission control system of claim 1 wherein the transmission is a hydromechanical transmission.

11. A method of operating a transmission of a vehicle steps comprising:
receiving a plurality of inputs at a control unit;
sending an output clutch signal to an input clutch that is mechanically connected to a transmission to modulate the input clutch;
sending a transmission ratio output signal to the transmission to set a ratio of the transmission; and
sending a range output signal to the transmission to determine the position of range clutches.

12. The method of claim 11 wherein the control unit uses digital logic.

13. The method of claim 11 wherein a pressure signal is sent from the transmission to the control unit as an input.

14. The method of claim 11 wherein a power demand signal associated with a power demand device is an input.

15. The method of claim 11 wherein an engine breaking signal associated with an engine braking device is an input.

16. The method of claim 11 wherein a range select signal associated with a range selecting device is an input.

17. The method of claim 11 wherein an operator inputs information into the control unit.

18. The method of claim 11 wherein the transmission is a hydromechanical transmission.
